(19) United States
(12) Patent Application Publication
(10) Pub. No.: US 2004/0236656 A1
(43) Pub. Date: Nov. 25, 2004

(54) Method for processing data relating to historical performance series of markets and/or of financial tools

(76) Inventors: Gaetano Megale, Milano (IT); Claudio Grossi, Cremona (IT)

Correspondence Address: SHERIDAN ROSS PC, 1560 BROADWAY, SUITE 1200, DENVER, CO, 80202

(21) Appl. No.: 10/642,377

(22) Filed: Aug. 14, 2003

(30) Foreign Application Priority Data
Apr. 1, 2003 (EP) 03425137.1

(51) Int. Cl. G06F 17/60

(52) U.S. Cl. 705/36; 705/37

(57) ABSTRACT

This describes a method of processing data relating to historical performance series (A₁, A₂, . . . , Aₘ) of markets and/or of financial tools to obtain a synthetic index (PROXYNTETICA) constituted of a plurality of historical performance series (Aₓ₁, Aₓ₂, . . . , Aₓₙ) representative of various economical and financial scenarios, which exhibits the particularity of being highly correlated with the last rolling of the market and of therefore maintaining a high representativity of the conditions relating to the covariances between the markets and/or the financial tools.

The present invention refers to a method of processing data relating to historical performance series of markets and/or of financial tools, such as for instance indexes of the share, bond and monetary market, stocks, common investment funds and the like.

As is well known in the financial field, the historical performance series of a market index, of a market index aggregate or of other financial tools are used to describe the risk/performance profile of that market (while also using statistical indexes such as the arithmetic average of the performances and the standard deviation of such performances).

Such historical performance series are also used to run estimates of future market evolution, such as for instance by applying the methodology of Montecarlo.

In these application environments, an important choice is the one relating to the number of performances composing a historical series.

From a strictly statistical viewpoint, in order to enhance the accuracy of the analyses or estimates it is appropriate to maximise the number of samples to the utmost, and to therefore perform analyses and processing over considerable time periods. However, this practice may prove to be counterproductive in the field of statistics applied to investment. Excessively long historical series may in fact diminish the degree of representativity of the sample, as today's risk/performance profile evolution of a financial market is decidedly poorly relevant to the economical and financial conditions of the same market a few decades ago.

In order to define optimum allocations of markets or portfolios of financial tools, optimising procedures are generally used, such as for instance the principles of Modern Portfolio Theory. There is, in these optimising procedures, a substantial impact of the covariances between the historical performance series of the elements under analysis. For this reason and for a better representativity of the correlations between historical series, it is appropriate that the number of samples not be excessively extensive. For this purpose it is common practice to use historical performance series derived, for instance, over 5 or 10-year time periods.

The use of historical series over limited time periods on one hand increases the representativity of the sampling with respect to the market, but on the other hand involves a reduction of the informative potential about the analysis of the trade-off of risk-performance and of the market evolution estimates referred thereto. More specifically, when using the statistical approach for financial market analysis (Random Walk Theory, a special case of the Efficient Market Hypothesis), the gaussian performance distribution to be derived from a single historical series would only incorporate the data of the economical and financial context it refers to, assuming that market in question would be inclined to remain tendentially stable in time.

However, in particular market situations (such as for instance the trend of the international share market of the years 1997-2002), the market analyses may evidence conditions depending on the statistical contingency of the exceptional rather than of the normal event (such as for instance the situation wherein the risk premium of the share market is less than that of the bond market, unlike what arises from the economical and financial theories and from the historical descriptions of the financial markets).

The same limit can be also be recognized as regards the optimisations of market or portfolio compositions.

In conclusion, the common use of the historical market performance series does not permit supplying an adequate information of the risk-performance profiles of the markets and/or of the financial tools in a historical perspective capable of allowing to consider a plurality of economical and financial conditions and therefore a timing of the investment in different historical scenarios.

The scope of the present invention is to eliminate the drawbacks of the known art, by supplying a method of processing the data relating to historical performance series of markets and/or of financial tools so as to obtain a synthetic index allowing to improve the accuracy and representativity of the statistical analyses and of the estimates of the risk-performance profile of such markets and/or financial tools.

This scope is achieved in accordance with the invention having the characteristics listed in the independent claim 1 attached.

Advantageous embodiments of the invention appear in the subordinate claims.

A few definitions of the mathematical and statistical tools adopted for implementing the method in accordance with the invention are described below.

Quota Q

Quota Q means a numerical value attributed by an organization, institute or more generally a provider of financial data (such as for instance by Morgan Stanley or JP Morgan), aiming to exploit, for example, a market index or a financial tool. Each quota Q refers to a given date.

Performance A

Performance A means the percentage variation of the quota Q referred to the same entity between two dates. If an initial quota Qᵢₙ referred to a date tₘ and a final quota Q_{fin} referred to t_{fin} with tᵢₙ<t_{fin} are given, the performance A in the period T=t_{fin}−tᵢₙ is calculated as follows:

$$A = \frac{{Q}_{fin} - {Q}_{i n}}{{Q}_{i n}} * 100 \qquad ( 1 )$$

This performance value A represents a percentage, in the sense that it assumes a meaning if followed by the percentage symbol “%”. Each performance is assigned a date t_{fin} as a date relating to the final quota Q_{fin}. In this manner, a pair (value A, date t_{fin}) is obtained for each performance that the value of the performance refers to.

Historical Performance Series

The historical performance series is an ordered series of performances calculated on quotas at a predetermined frequency. After establishing a given frequency k (daily, weekly, monthly etc.) to obtain a historical series of m performances, m performances are calculated (A₁, A₂, . . . , Aᵢ, Aᵢ₊₁, . . . Aₘ) with the frequency k, and ordered in accordance with the date of the performances in question.

The adjacent performances of the historical series have the following property: the performance Aᵢ and the performance Aᵢ₊₁ are constructed so that the final quota Q_{fin} relating to the performance Aᵢ is equal to the initial quota Qᵢₙ relating to the performance A_{i+1.}

Capitalization Index

If a performance Aᵢ is given, its relative capitalization index Iᵢ is obtained as follows:

$${I}_{i} = 1 + \frac{{A}_{i}}{100} \qquad ( 2 )$$

If therefore a series of m performances (A₁, A₂, . . . , Aₘ) is given, by applying the formula (2) a series of m capitalization indexes (Iᵢ, I₂, . . . , Iₘ) is obtained.

Logarithmic Series

By taking the natural logarithm ln(Iᵢ) of m capitalization indexes (I₁, I₂, . . . , Iₘ) of a given series, the corresponding logarithmic series (L₁, L₂, . . . , Lₘ) is obtained.

Rolling

Let a historical series of m performances (A₁, A₂, . . . , Aₘ) with a frequency k and a time window constituted by h adjacent performances with h≦m be given. Let n adjacent groups of the m performance dates be considered. Each group is formed by h performances derived by shifting the first performance of each group by the same full value δ, as δ<h≦m. Rolling of a degree h is defined as the aggregate of the n historical performance series thus obtained, whose cardinality may be calculated in accordance with the formula (3):

$$n = [ \frac{m - h}{δ} ] + 1 \qquad 3 )$$

Percentile

The percentile of a distribution of values is a numer Xₚ such that a percentage p of the values of the population turn out to be lower or equal to Xₚ. For example, the 25^{th} percentile (also known as quartile 0.25 or lower quartile) of a distribution of values is such an (Xₚ) that 25% (p) of the values of the distribution fall “below” the value itself. In particular, reference will be made here to the method of the empirical distribution function with interpolation, as explained below.

Let:

n be the number of cases

p be the percentage (f. ex., 50/100=0.5=50% for the median)

{x₁, x₂, . . . , xₙ} be the values of the distribution

The calculation of the percentile in accordance with the method of the empirical distribution with interpolation expresses (n−1)·p as (n−1)·p=j+g where j is the whole part of (n−1)·p, and g is the fractional part of (n−1)·p;

The percentile is then obtained as follows:

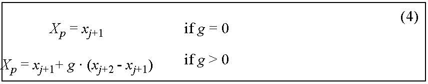

### EXAMPLE

In order to illustrate this percentile calculation method, consider the following ordered data xᵢ:

{1, 2, 4, 7, 8, 9, 10, 12, 13}

Let here n=9, and p=25% (the 25^{th} percentile).

(n−1)·p is expressed as:

(n−1)·p=8·0.25=2.0=j+g

therefore, j=2 e g=0

Now, because g=0, the 25^{th} percentile is calculated as follows:

X_{25%}=x₃=4.0

If instead the 30^{th} percentile, that is p=30% had been calculated while leaving the rest unchanged,

expressing (n−1)·p as:

(n−1)·p=8·0.30=2.4=j+g

then, j=2 e g=0.4

Now, because g>0, the 30^{th} percentile is calculated as follows:

X_{30%}=x₃+g·(x₄−x₃)=4+0.4·(7−4)=5.2

Statistical Scenario

Let there be given: a historical series of m performances (A₁, A₂, . . . , Aₘ), a rolling of grade h on this series with a cardinality n, a probability level P and s time intervals (T₁, T₂, . . . , Tₛ) each comprised between 1 and h.

Then calculate, for each of the n series of h performance, the relative series of the capitalization indexes {(I_{T1,1}, I_{T2,1}, . . . , I_{Ts,1}), (I_{T1,2}, I_{T2,2}, . . . , I_{Ts,2}), . . . , (I_{T1,n}, I_{T2,n}, . . . , I_{Ts,n})} at the times (T₁, T₂, . . . , Tₛ).

Considering the given probability P, take its complement to 100% and use this value to define a percentile according to (4). The calculate, in correspondence to each of the s time intervals given, the value of this percentile of the capitalization indexes of the rolling, that is

S_{(P, Ti)}=X_{(1-P)}{I_{Ti,k}} (5)

Where kε[1 . . . n] while iε[1 . . . s], the elements T₁ are the s time intervals given and X_{(1-P)}{I_{Ti,k}} means the calculation of the percentile applied to the aggregate of n capitalization indexes of the rolling, all considered at the same time interval Tᵢ. The statistical scenario on a probability P of a given historical series of m performances (A₁, A₂, . . . , Aₘ) is then defined as the series of s values (S_{(P,T1)}, S_{(P, T2)}, . . . , S_{(P,Ts)}) obtained as described in (5).

Control System

Let there be given a series of m performances (A₁, A₂, . . . , Aₘ), a probability level P and s time intervals (T₁, T₂, . . . , Tₛ), each comprised between 1 and m.

Calculate the complementary probability P*=100%−P.

For this complementary probability P* calculate the relative point Z representing the abscissa in respect to which the given probability is obtained, while calculating the probability on a normal distribution with a null average and a standard unitary deviation.

Calculate the geometric average Mg of the series of m capitalization indexes (I₁, I₂, . . . , Iₘ) corresponding to the given series of m performances.

Calculate the standard deviation DS₁ₙ of the logarithmic series (L₁, L₂, . . . , Lₘ) corresponding to the series of m performance data.

Calculate the s values of the curve relating to the probability level P in accordance with the following formula

C_{(P,T}_{ᵢ}₎=Mg^{T}^{ᵢ}*e^{(Z*DS}^{₁ₙ}^{*\sqrt{T^{₁}})} (6)

Where:

e is the Neperus number and iε[1 . . . s].

The control system of probability P is defined as the series of s values (C_{(P,T1)}, C_{(P,T2)}, . . . , C_{(P,Ts)}) obtained as described in (6).

Global Optimization Algorithm

A global optimization algorithm is used to implement the method according to the invention. Among the known global optimization algorithms the GLOBSOL software can be used, which implements a global optimisation algorithm based on a branch and bound method developed by R. Baker Kearfott at the Department of Mathematics of the University of Louisiana. The algorithm on which GLOBSOL is developed is contained in the book “Rigorous Global Search: Continuous Problems” edited by Kluwer Academic Publishers Dordrecht, Netherlands, in the chain NON CONVEX OPTIMIZATION AND ITS APPLICATION and is here incorporated as reference.

Other global optimizazion algorithms are found in the publication “Algorithms for Solving Nonlinear Constrained and Optimization Problems: The State of the Art” care of the COCONUT Project and available from the internet link: http://solon.cma.univie.ac.at/˜neum/glopt/coconut/StArt.html

At this point, a description will be given of the method of processing data relating to historical performance series of markets and/or of financial tools for obtaining a synthetic index, in accordance with the invention and to be referred in the following as PROXYNTETICA index.

The user has the following available as a starting point:

a historical series of m performances (A₁, A₂, . . . Aₘ).

The user therefore sets up the following parameters:

The number n of performances of the PROXYNTETICA index to be produced (with n≦m);

the value of the deviation δ that together with m and n defines the rolling to be used in the following

3 levels of probability (Pₘᵢₙ, Pₘₐₓ and 50% with Pₘᵢₙ<50%<Pₘₐₓ) to be utilized to define 3 control systems

3 levels of probability (P_{inf}, Pₛᵤₚ and 50% with P_{inf}<50%<Pₛᵤₚ) to be utilized to define 3 statistical scenarios

s time intervals (T₁, T₂, . . . , Tₛ), including the one equal to n (indicated as T*)

Using the data and parameters available to the user mentioned above, three statistical scenarios are calculated which are constructed in accordance with the 3 levels of probability (Pₘᵢₙ, Pₘₐₓ and 50%) and with the s time intervals (T₁, T₂, . . . , Tₛ), by applying the formula (5) to the historical series of m performances (A₁, A₂, . . . Aₘ).

The user finally:

sets up an increasing series of correlation values, meaning of numerical values comprised in the interval from −1 to +1;

selects an adequate non-linear programming algorithm for identifying the global optima. The user may utilize a software available on the market, such as for instance that developed by GLOBSOL, or may create his own software capable of implementing any global optimisation algorithm at the state of the art, such as for instance those described by the COCONUT Project.

The selected algorithm is set up using the data and parameters mentioned above, and is then subjected to specific constraints, as described below, so as to calculate an index named PROXYNTETICA min and an index named PROXYNTETICA max.

In order to calculate the index PROXYNTETICA min. and the index PROXYNTETICA max., n performances (Aₓ₁, Aₓ₂, . . . , Aₓₙ) are considered as the unknown variables of the problem. A objective function FO is then defined as a logarithmic standard deviation of the variables of the problem, meaning as the standard deviation of the logarithmic series of the variables of the problem.

This means:

FO=DS₁ₙ{Aₓ₁, Aₓ₂, . . . , Aₓₙ}

Calculation of the PROXYNTETICA Min Index

The algorithm is set up in a way that:

a) The n performances (Aₓ₁, Aₓ₂, . . . , Aₓₙ) are considered to be the unknown variables of the problem;

b) The objective function FO is minimized.

The algorithm is subjected to the following constraints:

1) The standard deviation DS of the variables of the problem (Aₓ₁, Aₓ₂, . . . , Aₓₙ) is to be greater or equal to the average M of the standard deviations DSₖ calculated on the rolling of grade n of the given historical series (A₁, A₂, . . . , Aₘ).

This means:

DS(Aₓⱼ)≧M {DSₖ(Aₖ . . . , Aₖ₊ₙ₋₁)} ∀jε[1 . . . n] and ∀kε[1 . . . r]

Where r is equal to the cardinality of the rolling calculated in accordance with the formula (3); DSₖ is the standard deviation calculated on the k-th group of n performances of the rolling.

2) The value of the control system at the probability of 50% (P_{med}) constructed on the variables of the problem (Aₓ₁, Aₓ₂, . . . , Aₓₙ) coincides with the value of the statistical scenario calculated on the given m performances (A₁, A₂, . . . , Aₘ) at the probability of 50% (P_{med},), both relating to the time interval T*.

This means:

C_{(Pmed,T*)}(Aₓ₁, Aₓ₂, . . . , Aₓₙ)=S_{(Pmed, T*)}(A₁, A₂, . . . , Aₘ)

3) the values of the control system (C_{(Pmax, T1)}, C_{(Pmax, T2)}, . . . , C_{(Pmax, Ts)}) of the variables of the problem (Aₓ₁, Aₓ₂, . . . , Aₓₙ) corresponding to the s time intervals and to the highest probability Pmax are to be higher than or coincident with the corresponding values of the statistical scenario (S_{(Psup; T1)}, S_{(Psup; T2)}, . . . , S_{(Psup; Ts)}) calculated on the given historical series (A₁, A₂, . . . , Aₘ) relating to the highest probability Pₛᵤₚ.

This means:

C(Pₘₐₓ, Tⱼ)(Aₓ₁, Aₓ₂ . . . , Aₓₙ)≦S_{(Psup; Tj)}(A₁, A₂, . . . , Aₘ) ∀jε[1 . . . s]

4) The values of the control system (C_{(Pmin, T1)}, C_{(Pmin, T2)}, . . . , C_{(Pmin, Ts)}) of the variables of the problem (Aₓ₁, Aₓ₂, . . . , Aₓₙ) corresponding to the s time intervals and to the lowest probability Pmin are to be higher than or coincident with the corresponding values of the statistical scenario (S_{(Pinf; T1)}, S_{(Pinf; T2)}, . . . , S_{(Pinf; Ts)}) calculated on the given historical series (A₁, A₂, . . . , Aₘ) relating to the lowest probability P_{inf}.

This means:

C(Pₘᵢₙ, Tⱼ)(Aₓ₁, Aₓ₂, . . . , Aₓₙ)≧S_{(Pinf; Tj)}(A₁, A₂, . . . , Aₘ) ∀jε[1 . . . n]

5) The correlation between the n problem variables (Aₓ₁, Aₓ₂, . . . , Aₓₙ) and the last n performances of the given historical series (A₁, A₂, . . . , Aₘ) is to be higher than or coincident with the highest correlation value Cmax among those given.

This means:

Correlation[(Aₓ₁, Aₓ₂, . . . , Aₓₙ); (A₍ₘ₋ₙ₎₊₁, A₍ₘ₋ₙ₎₊₂, . . . , A_{(m-n)+(n-1),} Aₘ)]≧Cₘₐₓ

Once these constraints have been set up, the algorithm starts working to give an output index value of PROXYNTETICA min. At every processing that supplies an unacceptable solution of the problem under constraint 5, the first correlation value considered is the one immediately below the current one.

The first elaboration with a positive result (meaning that producing an acceptable solution) supplies the solution of the problem. A series of n performances (Aₓ₁, Aₓ₂, . . . , Aₓₙ) is thus obtained, which constitutes the PROXYNTETICA min index.

Calculation Of The PROXYNTETICA Max Index

The algorithm is set up in a way that:

a) the n performances (Aₓ₁, Aₓ₂, . . . , Aₓₙ) are considered to be the unknown problem variables;

b) the objective function FO is maximized.

The algorithm is subjected to the following constraints:

1) Let the value of the control system at the probability of 50% (P_{med}) constructed on the problem variables (Aₓ₁, Aₓ₂, . . . , Aₓₙ) coincide with the value of the statistical scenario calculated on the given m performances (A₁, A₂, . . . , Aₘ) at the probability of 50% (P_{med}), both relating to the time interval T*.

This means:

C_{(Pmed,T*)}(Aₓ₁, Aₓ₂, . . . , Aₓₙ)=S_{(Pmed, T*)}(A₁, A₂, . . . , Aₘ)

2) Let the values of the control system (C_{(Pmax, T1)}, C_{(Pmax, T2)}, . . . , C_{(Pmax, Ts)}) of the problem variables (Aₓ₁, Aₓ₂, . . . , Aₓₙ) corresponding to the s time intervals and to the highest probability Pₘₐₓ be higher than or coincident with the corresponding values of the statistical scenario (S_{(Psup; T1)}, S_{(Psup; T2)}, . . . , S_{(psup; Ts)}) calculated on the given historical series (A₁, A₂, . . . , Aₘ) relating to the highest probability Pₛᵤₚ.

This means:

C_{(Pmax, Tj)}(Aₓ₁, Aₓ₂, . . . , Aₓₙ)≧S_{(Psup; Tj)}(A₁, A₂, . . . , Aₘ) ∀jε[1 . . . n]

3) Let the values of the control system (C_{(Pmin, T1)}, C_{(Pmin, T2)}, . . . , C_{(Pmin, Ts)}) of the problem variables (Aₓ₁, Aₓ₂, . . . , Aₓₙ) corresponding to the s time intervals and to the lowest probability Pₘᵢₙ be lower than or coincident with the corresponding values of the statistical scenario (S_{(Pinf; T1)}, S_{(Pinf; T2)}, . . . , S_{(Pinf; Ts)}) calculated on the given historical series (A₁, A₂, . . . , Aₘ) relating to the lowest probability P_{inf}.

This means:

C(Pₘᵢₙ, Tⱼ)(Aₓ₁, Aₓ₂, . . . , Aₓₙ)≦S_{(Pinf; Tj)}(A₁, A₂, . . . , Aₘ) ∀jε[1 . . . s]

4) Let the correlation between the n problem variables (Aₓ₁, Aₓ₂, . . . , Aₓₙ) and the last n performances of the given historical series (A₁, A₂, . . . , Aₘ) be higher than or coincident with the highest correlation value Cmax among those given.

This means:

Correlation[(Aₓ₁, Aₓ₂, . . . , Aₓₙ); (A₍ₘ₋ₙ₎₊₁, A₍ₘ₋ₙ₎₊₂, . . . , A₍ₘ₋ₙ₎₊₍ₙ₋₁₎, Aₘ)]≧Cₘₐₓ

It should be noted that in calculating the PROXYNTETICA max index the constraints 1) and 4) have remained unchanged, in this order, with respect to the constraints 2) and 5) in calculating the PROXYNTETICA min index.

Once these constraints have been set up, the algorithm starts working to give an output index value of PROXYNTETICA max. At every processing that supplies an unacceptable solution of the problem under constraint 4, the first correlation value is considered to be the one immediately below the current one.

The first elaboration with a positive result (meaning that producing an acceptable solution) supplies the solution of the problem. A series of n performances (Aₓ₁, Aₓ₂, . . . , Aₓₙ) is thus obtained, which constitutes the PROXYNTETICA max index.

Further characteristics of the invention will appear clearer in the descriptions of the PROXYNTETICA min and PROXYNTETICA max indexes, made for a purely exemplifying and non limiting usage and embodiment purpose, as illustrated in the attached drawings, in which:

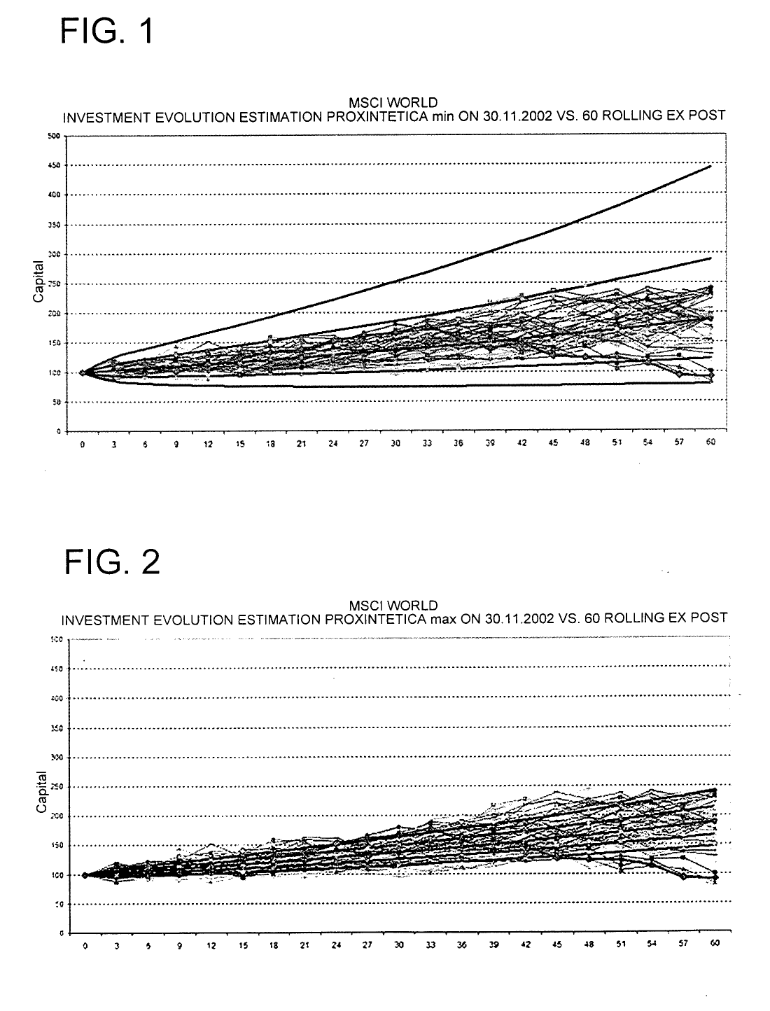

FIG. 1 is graph illustrating the evolution system of an investment, calculated by the PROXYNTETICA min index, for a 60 month rolling ex post, with a percentage comprised between 2%-98%, in which the months are indicated in the axis of the abscissas, and the capitals in the axis of the ordinates;

FIG. 2 is a graph, like FIG. 1, in which the evolution of the investment is calculated by the PROXYNTETICA max index;

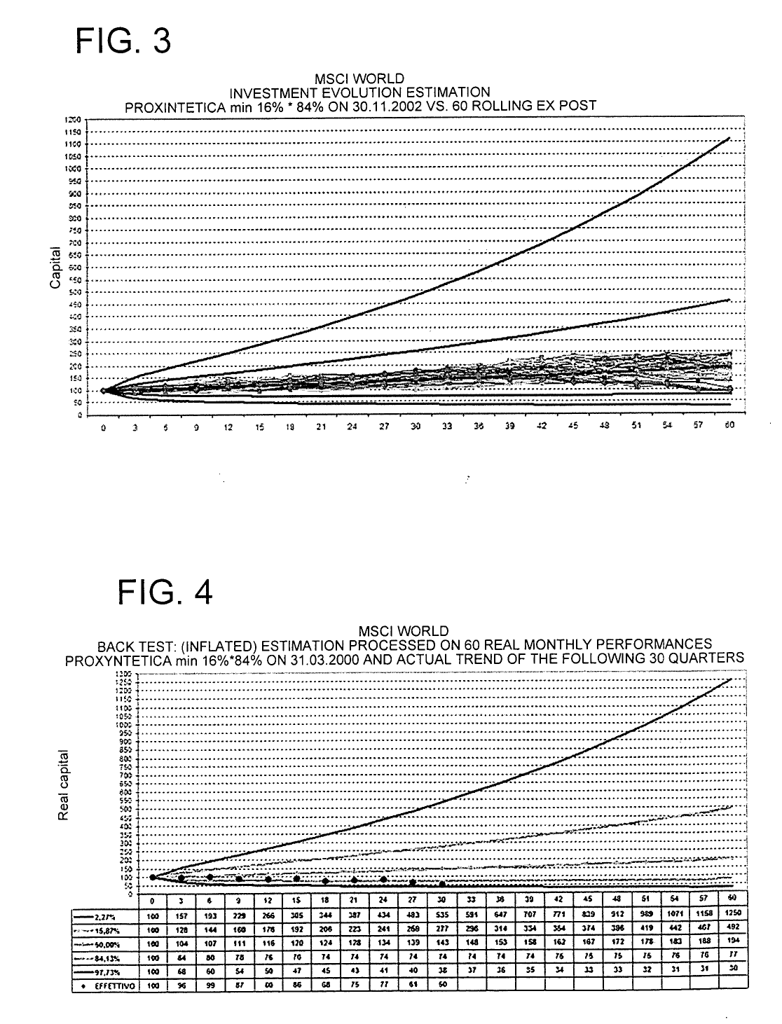

FIG. 3 is a graph like FIG. 1, showing the evolution system of an investment calculated by the PROXYNTETICA min index, with a percentage comprised between 16% X 84% of the control systems ex ante;

FIG. 4 is a graph illustrating the back test, meaning the (inflated) estimate processed on 60 real monthly performances of the PROXYNTETICA min index, calculated in the range of probability of 16%-84%, in which the table given below the graph shows the values calculated by using various percentages varying from 2.27% to 97.73%, and the actual value is marked by dots shown as ·;

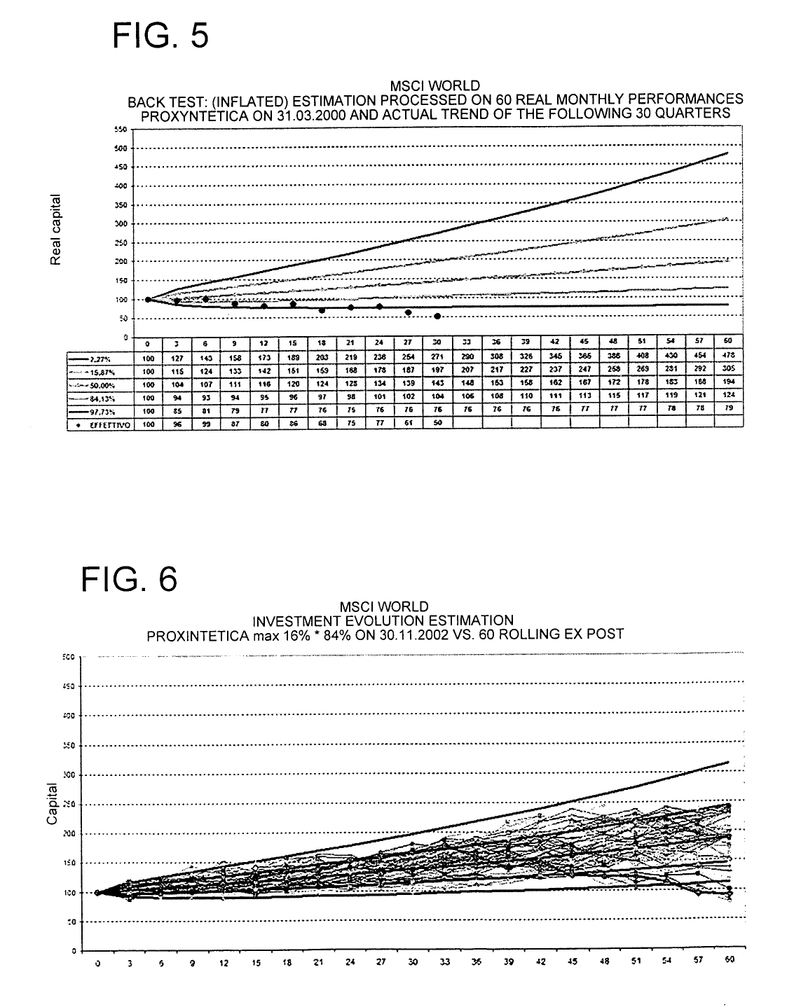

FIG. 5 is a graph, like FIG. 4, showing the back test of the PROXYNTETICA min index calculated in the probability range of 2%-98%;

FIG. 6 is a graph illustrating the evolution system of an investment calculated by the PROXYNTETICA max index, in a percentage comprised between 16% [symbol] >84% of the control systems ex ante.

From an algorithmic construction viewpoint, the PROXYNTETICA index can be produced in two versions, which differ by the purposes of their usage, while having the same general properties.

The two historical series resulting from the different processing procedures (PROXYNTETICA min and PROXYNTETICA max) produce considerably different control systems ex ante, as can be observed from FIG. 1 (PROXYNTETICA min) and from FIG. 2 (PROXYNTETICA max).

The algorithmic difference between the two versions relates to the different modality of incorporating the historical information of the rolling within the PROXYNTETICA series. In fact:

The modality PROXYNTETICA min generates a historical series which minimizes the value of the standard logarithmic deviation (with the constraint that the standard deviation of the generated series cannot be lower than the average standard deviation of the rolling), while maintaining that the estimate ex ante of the control systems must be outside the rolling values defined by a percentile range (for instance, from the 2^{nd} to the 98^{th} percentile, at 12 and 60 months);

The modality PROXYNTETICA max generates a historical series which maximizes the value of the standard logarithmic deviation, while maintaining that the estimate ex ante of the control systems must be comprised within the rolling values defined by a percentile range at different times (for instance, from the 2 to the 98th percentile, at 12 and 60 months);

It thus follows that:

The PROXYNTETICA min series describes the evolution of the risk-performance profile of the market, or of the composition of the markets, based on the assumption that the future trend may have a greater variability than that observed in history, and that it substantiates itself in a greater spread of the external control systems (at a probability of 2% and of 98%);

The PROXYNTETICA max series describes the evolution of the risk-performance profile of the market, or of the composition of the markets, based on the assumption that the future trend generally represents the variability of the trends observed in history (hypothesis of the constancy of the dispersion of trends).

The choice of the usage of the two index types is a function of the purposes envisioned by the user, depending on whether or not he requires a more prudent and accurate estimate of the evolution of the risk-performance profile.

For instance, in the processing of benchmarks for management lines to be offered to clients, an SGR may utilize the indexes of PROXYNTETICA min, in order to offer a more accurate indication as well as to avoid having to run into an eventual strategic revision of the benchmarks, with the consequence of activating an elaborate administrative procedure for a contractual acceptance of the change.

Viceversa, for a monitoring of the subsequent evolution of the investment structure capable of promptly signalling a change of the risk-performance profile with respect to the historical conditions, a consultant may employ the PROXYNTETICA max index, precisely for the purpose of being able to take a prompter action in strategically revising the investment structure.

The properties of the two versions may be further enhanced thanks to the versatility of the construction algorithm of the PROXYNTETICA series, which allows a finer definition of the number of percentiles relating to the historical rolling to be comprised within particular statistical scenarios ex ante, which are normally codified as follows:

2% [symbol] 98% (representing the area of normal distribution—ab. 95%—comprised between ±2 standard deviations);

16% [symbol] 84% (representing the area of normal distribution—ab. 68%·comprised between ±1 standard deviation);

For these possibilities, the PROXYNTETICA indexes may be processed so as to precisely reflect the user's theoretical hypotheses and requirements.

For example, the previous evolution estimates relating to the international share market have been processed within the following conditions:

100% of the historical rolling,

2% [symbol] 98% of the control systems ex ante.

The application of these conditions to the processing of the PROXYNTETICA min indexes means that the purpose is to identify a historical series whose extreme control systems ex ante (2% and 98%) contain 100% of the historical rolling (while also considering the outliers—meaning the extreme elements of rolling that may be interpreted as being particularly anomalous). The result is as shown in FIG. 1. If it were desired to set less “stringent”, thus less prudential conditions, a 98% rolling condition could be indicated.

If however an increase of the reliability and accuracy of the estimate were desired, the processing of PROXYNTETICA min. indexes could be considered within the following conditions: 100% of the historical rolling; 16% [symbol] 84% of the control systems ex ante. This means a wish to maintain 100% of the rolling within the control systems delimiting the range of normality, as can be observed from FIG. 3.

The greater accuracy of the estimate can be estimated by comparing the FIGS. 3 and 1 (PROXYNTETICA min. with ranges of 16%-84% and 2%-98%, respectively), as well as the FIGS. 4 and 5, relating to the results of the back test with processing up to 30.3.2000 (PROXYNTETICA min. with ranges of 16%-84% and 2%-98%, respectively).

From the comparisons it is entirely evident that there's a greater reliability of the estimate of the model containing 100% of the historical rolling within the range of normality (16%-84%) of the control systems. The increase in the reliability of the estimate is naturally opposed by a low sensitivity in registering and signalling a structural change of the market during the following monitoring activities.

The same statement applies to the version PROXYNTETICA max, whose condition, 100% of the historical rolling, 16% [symbol] 84% of the control systems ex ante defines an estimate of the international share market as per FIG. 6, whose comparison with FIG. 2 allows appreciating the difference of reliability.

In the following, a description will be given of further versions of the PROXYNTETICA index as a function of the time of investment.

An additional possibility of PROXYNTETICA consists in defining a database of the performances of indexes specifically adapted to the time of investment.

As an example, if the investment is finalized to a probabilistic maximisation of a certain sum at a given time, it is possible to define a representation of the historical performance series of the markets, separately processed for the time period defined. This involves that the database versions can incorporate the historical data of the individual market indexes and/or of the optimisations with respect to that particular time of analysis, thus increasing the accuracy of the analyses and of the processing and enhancing the reliability of the statistical estimates ex ante.

The methodology of construction of the PROXYNTETICA index thus synthesizes the risk-performance potential derived from an appropriate number of historical performance series representative of various economical and financial scenarios (rolling). The final result is a synthetic historical performance series which exhibits the particularity of being highly correlated with the last rolling of the market, and therefore of maintaining a high representativity of the covariances between the markets and/or the financial tools.

For these reasons, the synthetic PROXYNTETICA index may be utilized for describing the risk-performance profiles of individual markets and/or of financial tools, or of aggregates of markets and/or of financial tools. The synthetic PROXYNTETICA index may also be utilized to identify optimum allocations, by calculating algorithms (such as for instance risk premium optimisers derived from the Modern Portfolio Theory or probability optimisers) which elaborate such synthetic PROXYNTETICA indexes, thus increasing the accuracy of the analyses and of the statistical estimates, and reducing their sampling error.

1. A method of processing data relating to historical performance series (A₁, A₂, . . . , Aₘ) of markets and/financial tools to obtain a synthetic index (PROXYNTETICA) constituted by a series of performances (Aₓ₁, Aₓ₂, . . . , Aₓₙ) representative of various economical and financial scenarios, where the method comprises the following steps:
acquiring data relating to a historical series of m performances (A₁, A₂, . . . , Aₘ)
setting up a given number (n) representing the number of performances (Aₓ₁, Aₓ₂, . . . , Aₓₙ) to be produced for constituting the index (PROXYNTETICA),
setting up a first number of probability levels (Pₘᵢₙ, Pₘᵢₙ and 50%) to utilize for defining control systems and a second number of probability levels (Pinf, P sup and 10 50%) to utilize for defining statistical scenarios,
setting up (s) time intervals (T₁, T₂, . . . , Tₛ) including the time interval (T*) equal to the given number (n), in which particular mathematical constraints are to be verified between the curves of the control system originated by the performances (Aₓ₁, Aₓ₂, . . . , Aₓₙ) of the index (PROXYNTETICA) and the statistical scenarios obtained from the given historical performance series (A₁, A₂, . . . , Aₘ),
calculating a number of statistical scenarios {Scenario (Pi, TJ) constructed in accordance with said second number of probability levels and the (s) time intervals, wherein iε[1 . . . p] and jε[1 . . . s],
setting up a growing series of correlation values,
selecting a non-linear programming algorithm for identifying the global optima,
setting up said algorithm so that the same:
a) assumes the (n) performances (Aₓ₁, Aₓ₂, . . . , Aₓₙ) as the unknown variables to be produced for constituting the synthetic index (pROXYNTETICA),
b) minimizes and/or maximizes a objective function (FO) obtained as a standard logarithmic deviation from the unknown variables (Aₓ₁, Aₓ₂, . . . , Aₓₙ), and
setting up constraints for the algorithm implementing process, so that said algorithm calculates the unknown variables (Aₓ₁, Aₓ₂, . . . , Aₓₙ) for a minimum and/or maximum synthetic index (PROXYNTETICA min and/or PROXYNTETICA max).

2. The method according to claim 1, characterized in that said first number of probability levels for defining control systems is constituted of three probability levels (Pₘᵢₙ, Pₘᵢₙ and 50%) comprising an average probability level equal to 50%, a minimum probability level (Pₘᵢₙ)<50% and a maximum probability level (Pₘₐₓ)>50%.

3. The method according to claim 1, characterized in that said second number of probability levels for defining statistical scenarios is constituted of three probability levels (P_{inf}, Pₛᵤₚ and 50%) comprising an average probability level equal to 50%, a lower probability level (P_{inf})<50% and a higher probability level (Pₛᵤₚ)>50%.

4. The method according to claim 3, characterized in that said number of statistical scenarios (Scenario (pi, Tj)) is equal to three statistical scenarios constructed in accordance to said three levels of probability (P_{inf}, Pₛᵤₚ and 50%).

5. The method according to claim 1, characterized in that said constraints imposed on said algorithm for calculating the minimum synthetic index (PROXYNTETICA min) comprise that:
a) the standard deviation DS of the problem variables (Aₓ₁, Aₓ₂, . . . , Aₓₙ) is to be greater than or equal to the average M of the standard deviations DSₖ, calculated on the rolling of grade n of the given historical series (A₁ A₂, . . . , Aₘ),
b) the value of the control system at the probability of 50% (P_{med}) constructed on the problem variables (Aₓ₁, Aₓ₂, . . . , Aₓₙ) is to coincide with the value of the statistical scenario calculated on the given m performances (A₁ A2 . . . , Aₘ), at the probability of 50% (Pmed), both relating to the n-th time interval,
c) the values of control system of the problem variables (Aₓ₁, Aₓ₂, . . . , Aₓₙ) corresponding to the s time intervals and to the maximum probability (Pₘₐₓ) are to be lower than or coincident with the corresponding values of the statistical scenario calculated on the given historical series (A₁ A₂, . . . , Aₘ) relating to the highest probability (Pₛᵤₚ)
d) the values of the control system of the problem variables (Aₓ₁, Aₓ₂, . . . , Aₓₙ) corresponding to the s time intervals and to the minimum probability (Pₘᵢₙ) are to be higher than or coincident with the corresponding values of the statistical scenario calculated on the given historical series (A₁ A2, . . . , Aₘ) relating to the lowest probability (P_{inf}), and
e) the correlation between the n problem variables (Aₓ₁, Aₓ₂, . . . , Aₙ) and the last n performances of the given historical series (A₁ A2, . . . , Aₘ) is to be equal to the highest possible value among those given for the correlation.

6. The method according to claim 1, characterized in that said constraints imposed on said algorithm for calculating the maximum synthetic index (PROXYNTETICA max) comprise that:
a) the value of the control system at the probability of 50% (P_{med}) constructed on the problem variables (Aₓ₁, Aₓ₂, . . . , Aₓₙ) is to coincide with the value of the statistical scenario calculated on the given m performances (A₁ A2, . . . , Aₘ), at the probability of 50% (P_{med}), both relating to the time interval T*,
b) the values of control system of the problem variables (Aₓ₁, Aₓ₂, . . . , Aₓₙ) corresponding to the s time intervals and to the maximum probability (Pₘₐₓ) are to be higher than or coincident with the corresponding values of the statistical scenario calculated on the given historical series (A₁ A₂, . . . Aₘ) relating to the highest probability (P_{sup),}
c) the values of the control system of the problem variables (Aₓ₁, Aₓ₂, . . . , Aₓₙ) corresponding to the s time intervals and to the minimum probability (Pₘᵢₙ) are to be lower than or coincident with the corresponding values of the statistical scenario calculated on the given historical series (A₁ A2, . . . , Aₘ), relating to the lowest probability (P_{inf}), and
d) the correlation between the n problem variables (Aₓ₁, Aₓ₂, . . . , Aₓₙ) and the last n performances of the given historical series (A₁ A₂, . . . , Aₘ) is be equal to the highest possible value among those given for the correlation.

7. The method according to claim 5, characterized in that at each processing of said algorithm supplying a solution unacceptable under the constraint regarding the correlation between the n problem variables (Aₓ₁, Aₓ₂, . . . , Aₓₙ) and the last n performances of the given historical series (A₁ A₂, . . . , Aₘ), the first value of correlation considered is the one lower than the current value.

8. The method according to claim 1, characterized in that said non-linear programming for identifying the global optima is an algorithm implemented in the GLOBSOL software.
